(19) United States
(12) Patent Application Publication
(10) Pub. No.: US 2014/0000063 A1
(43) Pub. Date: Jan. 2, 2014

(54) ADJUSTABLE UNIT FOR TABLE LAMP

(71) Applicant: Hang-John LIN, Taichung City (TW)

(72) Inventor: Hang-John LIN, Taichung City (TW)

(21) Appl. No.: 13/537,036

(22) Filed: Jun. 28, 2012

(51) Int. Cl. E05D 11/08

(52) U.S. Cl. 16/337

(57) ABSTRACT

A table lamp includes an arm pivotably connected to an adjustment unit located in a base. The adjustment unit has an operation wheel which has a first toothed face. A disk has a second toothed face which is engaged with the first toothed face. A pivot extends through the operation wheel, the disk, the arm, a resilient ring, a washer and the base. When the arm is pivoted, the operation wheel is rotated and the first toothed face moves over the second toothed face while the resilient ring is squeezed. When the first toothed face is engaged with the second toothed face again, the arm is secured again. The arm is pivoted within a recess of the base, and the recess opens between 90 degrees to 110 degrees, the arm can be pivoted to be parallel to the base to save the packing room.

### FIELD OF THE INVENTION

The present invention relates to an adjustment unit for a table lamp, and more particularly, to an adjustment unit for adjusting the angle of the table lamp.

### BACKGROUND OF THE INVENTION

The conventional table lamp includes a base and an arm which is pivotably connected to the base by bolts which extend through the base from two sides of the base. The light bulb and the shade are connected to the top of the arm. By tightening the bolts to set the angle of the table lamp and the arm is loosened so as to be adjusted by loosening the bolts.

However, the use of the two bolts extending through the base from the two sides of the base to set the position of the arm has a drawback which is that the threads of the bolts are worn out after a period of time of use. Once the bolts cannot hold the arm, the angle of the table lamp cannot be set. Furthermore, the users have to rotate the bolts to pivot the arm to adjust the angle of the table lamp. The range of the arm that can be adjusted relative to the base is limited. The conventional table lamp requires a lot of packing room.

The present invention intends to provide an adjustment unit for a table lamp and the adjustment unit improves the shortcomings of the conventional table lamp.

### SUMMARY OF THE INVENTION

The present invention relates to a table lamp and comprises an adjustment unit having an operation wheel, a first member, a disk, a resilient ring, a disk and a second member. The operation wheel has a groove defined in the top thereof and a first toothed face is defined in the first side of the rotor. The first member and the second member are respectively located on two sides of the operation wheel. The disk has two engaging portions extending from the first side thereof and a second toothed face is defined in the second side of the disk. The first member is located between the two engaging portions. The first and second toothed faces are engaged with each other. The resilient ring and the washer are matched with the second side of the operation wheel. The pivot extends through disk, the first member, the resilient ring, the washer and the second member. A base has a recess and two clamp portions are respectively located on two sides of the recess. One of the clamp portions has an engaging slot. The adjustment unit is located between the two clamp portions in the recess of the base. The first member is engaged with the engaging slots of the clamp portions. An arm has an insertion end which extends into the recess and is connected to the groove of the adjustment unit.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the table lamp with the adjustment unit of the present invention;

FIG. 2 is an exploded view to show the table lamp with the adjustment unit of the present invention;

FIG. 3 is a side view to show the table lamp with the adjustment unit of the present invention;

FIG. 4 is a side cross sectional view of the table lamp with the adjustment unit of the present invention;

FIG. 5 shows that the arm of the table lamp is pivoted, and

FIG. 6 is a rear end cross sectional view of the table lamp with the adjustment unit of the present invention.

### DETAILED DESCRIPTION OF THE PREFERRED EMBODIMENT

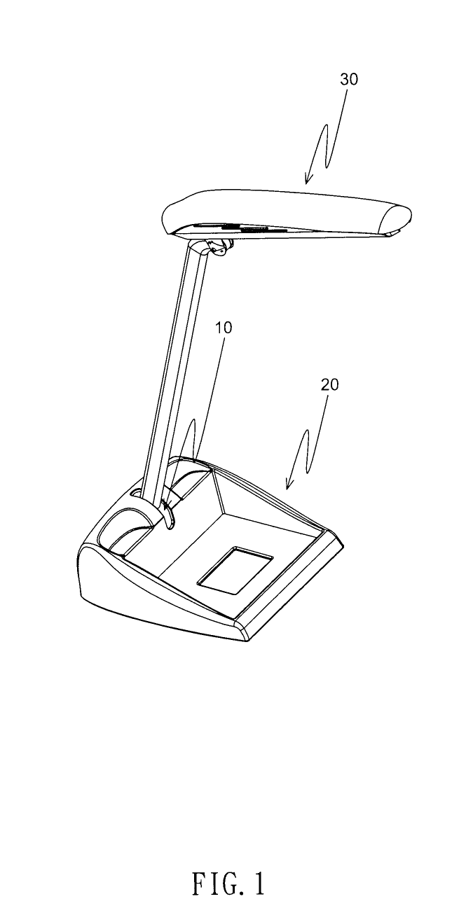

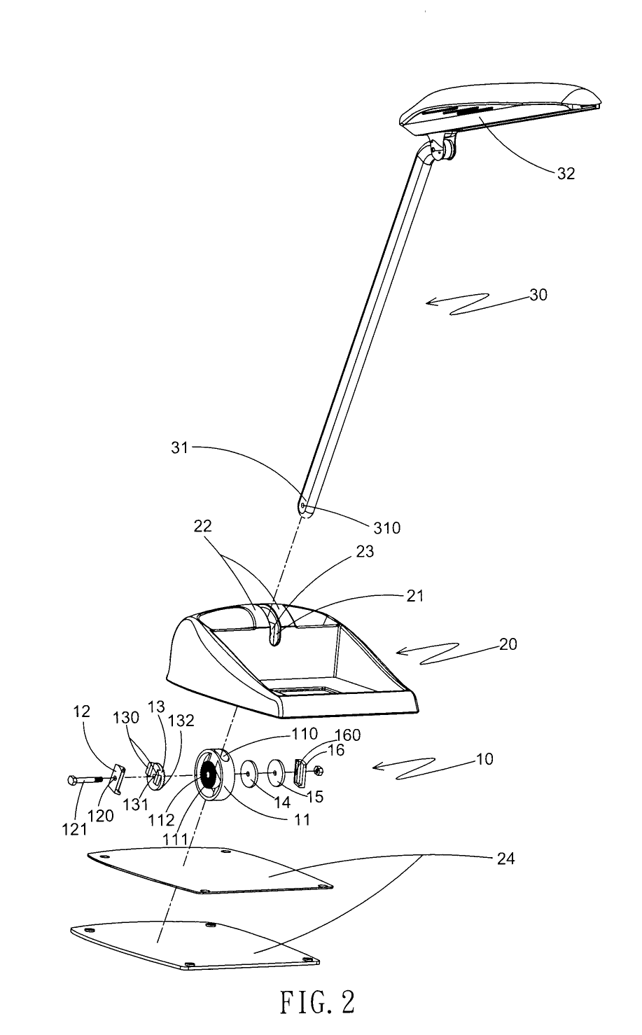

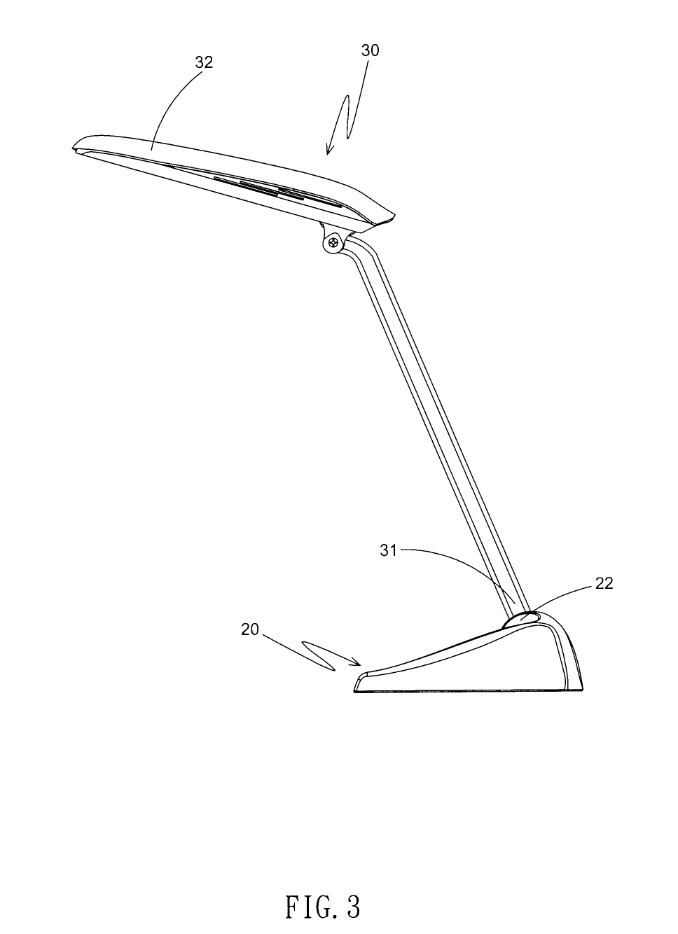

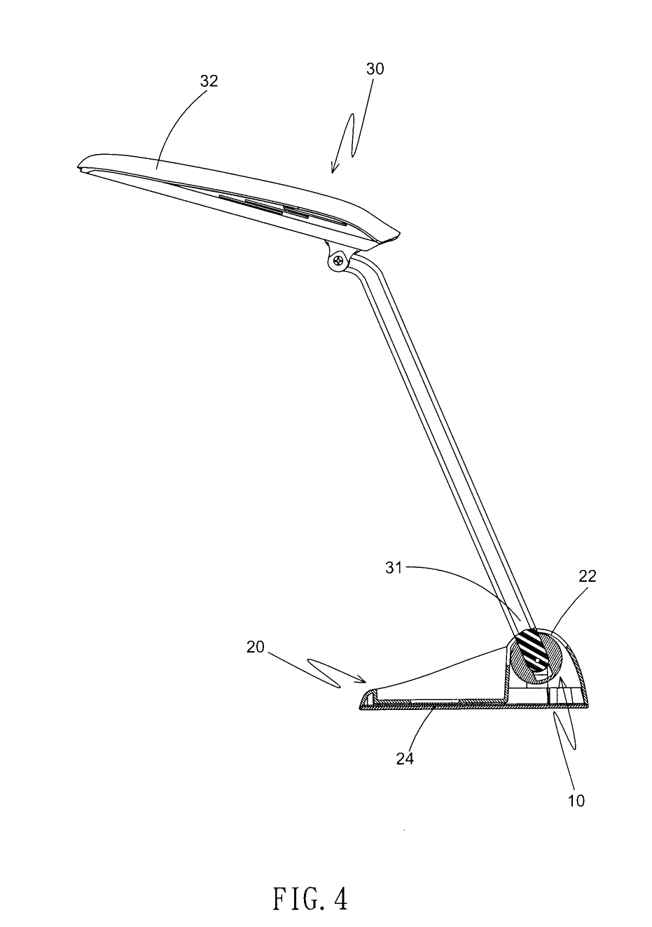

Referring to FIGS. 1 to 4, the table lamp of the present invention comprises an adjustment unit 10 having an operation wheel 11, a first member 12, a disk 13, a resilient ring 14, a disk 15 and a second member 16. The operation wheel has a groove 21 defined in a top portion thereof and a first toothed face 111 is defined in the first side of the rotor 11. A guide hole 112 is defined through the operation wheel 11. The first member 12 and the second member 16 are respectively located on two sides of the operation wheel 11, wherein the first member 12 has a first hole 120 defined therethrough and the second member 16 has a second hole 160 defined therethrough. A pivot 121 extends through the first hole 120. The disk 13 has two engaging portions 130 extending from the first side thereof and a third hole 131 is defined centrally through the disk 13. A second toothed face 132 is defined in the second side of the disk 13. The first member 12 is located between the two engaging portions 130, and the first and second toothed faces 111, 132 are engaged with each other.

The resilient ring 14 and the washer 15 are matched with the second side of the operation wheel 11. The pivot 11 further extends through third hole 131, the guide hole 112, the resilient ring 14, the washer 15 and the second hole 160 of the second member 16.

A base 20 has a recess 21 defined therein and two clamp portions 22 are respectively located on two sides of the recess 21. One of the clamp portions 22 has an engaging slot 23. A bottom board 24 is connected to the bottom of the base 20. The adjustment unit 10 is located between the two clamp portions 22 in the recess 21 of the base 20. The first member 12 is engaged with the engaging slot 23 of the clamp portion 22.

An arm 30 has an insertion end 31 which extends into the recess 21 and is connected to the groove 110 of the adjustment unit 10. A shade 32 is connected to the other end of the arm 30. The insertion end 31 of the arm 30 has a connection hole 310, the pivot 121 extends through the first hole 120 and the connection hole 310.

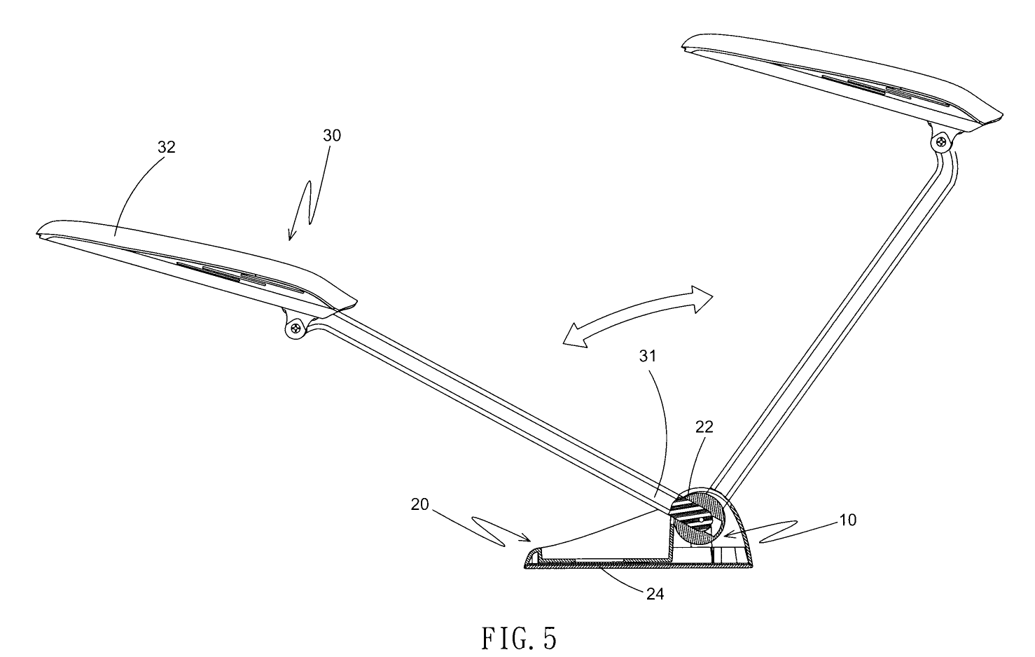

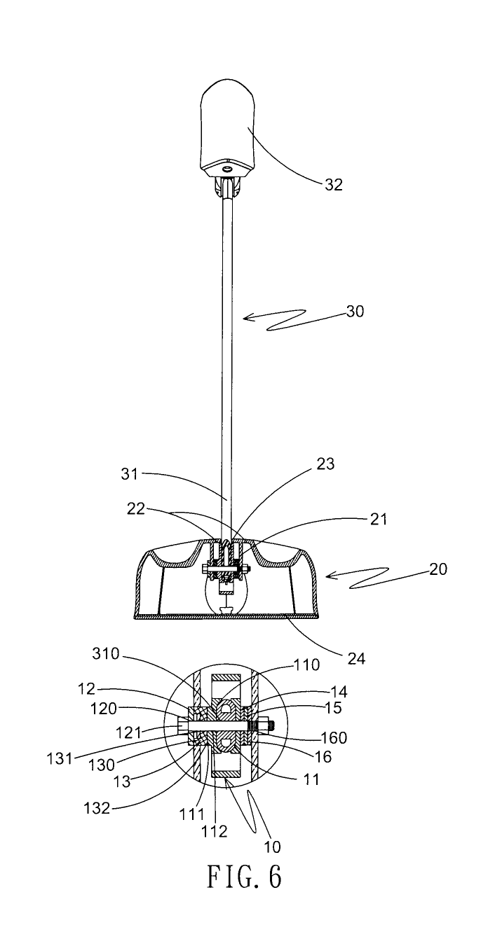

As shown in FIGS. 5 and 6, the adjustment unit 10 is located between the two clamp portions 22 in the recess 21 of the base 20, and the first member 12 is engaged with the engaging slot 23 of the clamp portion 22. The arm 30 is pivotably connected to the adjustment unit 10 and the base 20 by the pivot 121. By pivoting the arm 30 to rotate the operation wheel 11, the first toothed face 111 moves over the second toothed face 132 while the resilient ring 14 is squeezed to allow the teeth of the first toothed face 111 move over the teeth of the second toothed face 132 with less friction. When the arm 30 is pivoted to a desired position, the teeth of the first toothed face 111 are engaged with the teeth of the second toothed face 132 to set the arm 30. It is noted that the opening of the recess 21 extends between 90 degrees to 110 degrees, so that the arm 30 can be pivoted to be parallel to the base 20 to save the room of packing when the table lamp is not in use.

The resilient ring 14 is squeezed when the arm 30 is pivoted so that the friction between the teeth of the first toothed face 111 and the teeth of the second toothed face 132, such that the adjustment of the arm 30 can be made with less friction and this makes the adjustment unit 10 have a longer life.

The opening of the recess 21 extends between 90 degrees to 110 degrees to allow the arm 30 to be pivoted to a position that is parallel to the base 20 to save the room of packing when the table lamp is not in use.

While we have shown and described the embodiment in accordance with the present invention, it should be clear to those skilled in the art that further embodiments may be made without departing from the scope of the present invention.

What is claimed is:

1. An adjustment unit comprising:
an operation wheel having a groove defined in a top portion thereof and a first toothed face defined in a first side of the operation wheel, a guide hole defined through the operation wheel;
a first member and a second member respectively located on two sides of the operation wheel, the first member having a first hole defined therethrough and the second member having a second hole defined therethrough, a pivot extending through the first hole;
a disk having two engaging portions extending from a first side thereof and a third hole defined centrally through the disk, a second toothed face define in a second side of the disk, the first member being located between the two engaging portions, the first and second toothed faces being engaged with each other, and
a resilient ring and a washer matched with a second side of the operation wheel, the pivot extending through third hole, the guide hole, the resilient ring, the washer and the second hole of the second member.

2. The table lamp comprising:
an adjustment unit having an operation wheel, a first member, a disk, a resilient ring, a disk and a second member, the operation wheel having a groove defined in a top portion thereof and a first toothed face defined in a first side of the rotor, a guide hole defined through the operation wheel;
the first member and the second member respectively located on two sides of the operation wheel, the first member having a first hole defined therethrough and the second member having a second hole defined therethrough, a pivot extending through the first hole;
the disk having two engaging portions extending from a first side thereof and a third hole defined centrally through the disk, a second toothed face defined in a second side of the disk, the first member being located between the two engaging portions, the first and second toothed faces being engaged with each other;
the resilient ring and the washer matched with a second side of the operation wheel, the pivot extending through third hole, the guide hole, the resilient ring, the washer 15 and the second hole of the second member;
a base having a recess defined therein and two clamp portions respectively located on two sides of the recess, one of the clamp portions having an engaging slot, a bottom board connected to a bottom of the base, the adjustment unit located between the two clamp portions in the recess of the base, the first member engaged with the engaging slot of the clamp portion, and
an arm having an insertion end which extends into the recess and connected to the groove of the adjustment unit.

3. The table lamp as claimed in claim 2, wherein the insertion end of the arm has a connection hole, the pivot extends through the first hole and the connection hole.

4. The table lamp as claimed in claim 2, wherein an opening of the recess extends between 90 degrees to 110 degrees.
